(19) United States
(12) Patent Application Publication
(10) Pub. No.: US 2016/0334969 A1
(43) Pub. Date: Nov. 17, 2016

(54) Methods and Systems for Viewing an Associated Location of an Image

(71) Applicant: Facebook, Inc., Menlo Park, CA (US)

(72) Inventors: Michael Waldman Reckhow, San Francisco, CA (US); Michael James Matas, Healdsburg, CA (US)

(21) Appl. No.: 14/923,306

(22) Filed: Oct. 26, 2015

Related U.S. Application Data
(60) Provisional application No. 62/159,889, filed on May 11, 2015.

(51) Int. Cl. G06F 3/0484; G06F 3/0481

(52) U.S. Cl. CPC G06F 3/04842; G06F 3/04817

(57) ABSTRACT

At an electronic device having one or more processors and memory storing one or more programs for execution by the one or more processors, an image and a location affordance associated with the image are concurrently displayed. The image has an associated location and corresponds to a source media item that was generated at the associated location. A selection of the location affordance is detected. In response to detecting selection of the location affordance, a map showing the associated location of the image is displayed.

### RELATED APPLICATIONS

This application claims priority to U.S. Provisional Patent Application No. 62/159,889 filed May 11, 2015, which is hereby incorporated by reference in its entirety.

### TECHNICAL FIELD

This relates generally to viewing images, including but not limited to viewing an association location of an image.

### BACKGROUND

The Internet has become an increasingly dominant platform for the publication of electronic content, for both the media and the general population. Electronic content takes on many forms, some with which a consumer can interact, such as embedded pictures or videos a consumer may view and manipulate.

As the use of mobile devices for digesting electronic content becomes more prevalent, consumers often struggle to view and interact with embedded content in an efficient and effective manner, particularly with respect to viewing and retrieving information related to embedded content.

### SUMMARY

Accordingly, there is a need for methods, systems, and interfaces for viewing a location associated with an image in a simple and efficient manner. By allowing users to select a location affordance to display an associated location of an image on a map, users can efficiently and easily view and retrieve location information for the image. Such methods and interfaces optionally complement or replace conventional methods for viewing an associated location of an image.

In accordance with some embodiments, a method is performed at an electronic device (e.g., a client device) with one or more processors and memory storing instructions for execution by the one or more processors. The method includes concurrently displaying an image and a location affordance associated with the image. The image has an associated location and corresponds to a source media item that was generated at the associated location. A selection of the location affordance is detected. In response to detecting selection of the location affordance, a map showing the associated location of the image is displayed.

In accordance with some embodiments, an electronic device (e.g., a client device) includes one or more processors, memory, and one or more programs; the one or more programs are stored in the memory and configured to be executed by the one or more processors. The one or more programs include instructions for performing the operations of the method described above. In accordance with some embodiments, a non-transitory computer-readable storage medium has stored therein instructions that, when executed by the electronic device, cause the electronic device to perform the operations of the method described above.

Thus, electronic devices are provided with more effective and efficient methods for viewing a location associated with an image, thereby increasing the effectiveness and efficiency of such devices and user satisfaction with such devices.

### BRIEF DESCRIPTION OF THE DRAWINGS

For a better understanding of the various described embodiments, reference should be made to the Description of Embodiments below, in conjunction with the following drawings. Like reference numerals refer to corresponding parts throughout the figures and description.

FIG. 1 is a block diagram illustrating an exemplary network architecture of a social network in accordance with some embodiments.

FIG. 2 is a block diagram illustrating an exemplary social-network system in accordance with some embodiments.

FIG. 3 is a block diagram illustrating an exemplary client device in accordance with some embodiments.

FIGS. 4A-4E illustrate exemplary graphical user interfaces (GUIs) on a client device for viewing an associated location of an image, in accordance with some embodiments.

FIGS. 5A-5B are flow diagrams illustrating a method of viewing an associated location of an image, in accordance with some embodiments.

### DESCRIPTION OF EMBODIMENTS

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first portion of a content item could be termed a second portion of the content item, and, similarly, a second portion of the content item could be termed a first portion of the content item, without departing from the scope of the various described embodiments. The first portion of the content item and the second portion of the content item are both portions of the content item, but they are not the same portion.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

As used herein, the term “exemplary” is used in the sense of “serving as an example, instance, or illustration” and not in the sense of “representing the best of its kind.”

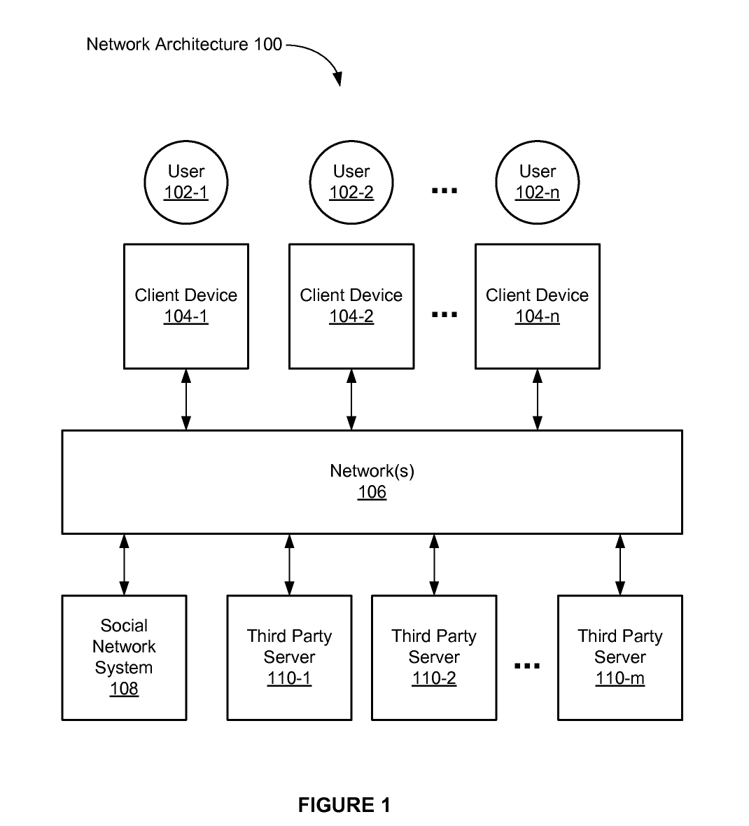

FIG. 1 is a block diagram illustrating an exemplary network architecture 100 of a social network in accordance with some embodiments. The network architecture 100 includes a number of client devices (also called “client systems,” “client computers,” or “clients”) 104-1, 104-2, . . . 104-n communicably connected to an electronic social-network system 108 by one or more networks 106 (e.g., the Internet, cellular telephone networks, mobile data networks, other wide area networks, local area networks, metropolitan area networks, and so on). In some embodiments, the one or more networks 106 include a public communication network (e.g., the Internet and/or a cellular data network), a private communications network (e.g., a private LAN or leased lines), or a combination of such communication networks.

In some embodiments, the client devices 104-1, 104-2, . . . 104-n are computing devices such as smart watches, personal digital assistants, portable media players, smart phones, tablet computers, 2D gaming devices, 3D (e.g., virtual reality) gaming devices, laptop computers, desktop computers, televisions with one or more processors embedded therein or coupled thereto, in-vehicle information systems (e.g., an in-car computer system that provides navigation, entertainment, and/or other information), and/or other appropriate computing devices that can be used to communicate with the social-network system 108. In some embodiments, the social-network system 108 is a single computing device such as a computer server, while in other embodiments, the social-network system 108 is implemented by multiple computing devices working together to perform the actions of a server system (e.g., cloud computing).

Users 102-1, 102-2, . . . 102-n employ the client devices 104-1, 104-2, . . . 104-n to access the social-network system 108 and to participate in a corresponding social-networking service provided by the social-network system 108. For example, one or more of the client devices 104-1, 104-2, . . . 104-n execute web browser applications that can be used to access the social-networking service. As another example, one or more of the client devices 104-1, 104-2, . . . 104-n execute software applications that are specific to the social-networking service (e.g., social-networking “apps” running on smart phones or tablets, such as a Facebook social-networking application running on an iPhone, Android, or Windows smart phone or tablet).

Users interacting with the client devices 104-1, 104-2, . . . 104-n can participate in the social-networking service provided by the social-network system 108 by posting information, such as text comments (e.g., updates, announcements, replies), digital photos, videos, audio files, links, and/or other electronic content. Users of the social-networking service can also annotate information posted by other users of the social-networking service (e.g., endorsing or “liking” a posting of another user, or commenting on a posting by another user). In some embodiments, information can be posted on a user's behalf by systems and/or services external to the social-network system 108. For example, the user may post a review of a movie to a movie-review website, and with proper permissions that website may cross-post the review to the social network system 108 on the user's behalf. In another example, a software application executing on a mobile client device, with proper permissions, may use global positioning system (GPS) or other geo-location capabilities (e.g., Wi-Fi or hybrid positioning systems) to determine the user's location and update the social network system 108 with the user's location (e.g., “At Home”, “At Work”, or “In San Francisco, Calif.”), and/or update the social network system 108 with information derived from and/or based on the user's location. Users interacting with the client devices 104-1, 104-2, . . . 104-n can also use the social-networking service provided by the social-network system 108 to define groups of users. Users interacting with the client devices 104-1, 104-2, . . . 104-n can also use the social-networking service provided by the social-network system 108 to communicate and collaborate with each other.

In some embodiments, the network architecture 100 also includes third-party servers 110-1, 110-2, . . . 110-m. In some embodiments, a given third-party server 110 is used to host third-party websites that provide web pages to client devices 104, either directly or in conjunction with the social-network system 108. In some embodiments, the social-network system 108 uses inline frames (“iframes”) to nest independent websites within a user's social network session. In some embodiments, a given third-party server is used to host third-party applications that are used by client devices 104, either directly or in conjunction with the social-network system 108. In some embodiments, the social-network system 108 uses iframes to enable third-party developers to create applications that are hosted separately by a third-party server 110, but operate within a social-networking session of a user 102 and are accessed through the user's profile in the social-network system 108. Exemplary third-party applications include applications for books, business, communication, contests, education, entertainment, fashion, finance, food and drink, games, health and fitness, lifestyle, local information, movies, television, music and audio, news, photos, video, productivity, reference material, security, shopping, sports, travel, utilities, and the like. In some embodiments, a given third-party server 110 is used to host enterprise systems, which are used by client devices 104, either directly or in conjunction with the social-network system 108. In some embodiments, a given third-party server 110 is used to provide third-party content, such as content items (e.g., news articles, reviews, message feeds, etc.). Content items may include embedded content (e.g., text, photos, videos, audio, and/or other electronic content with which a user may interact, such as interactive maps, games, etc.).

In some embodiments, a given third-party server 110 is a single computing device, while in other embodiments, a given third-party server 110 is implemented by multiple computing devices working together to perform the actions of a server system (e.g., cloud computing).

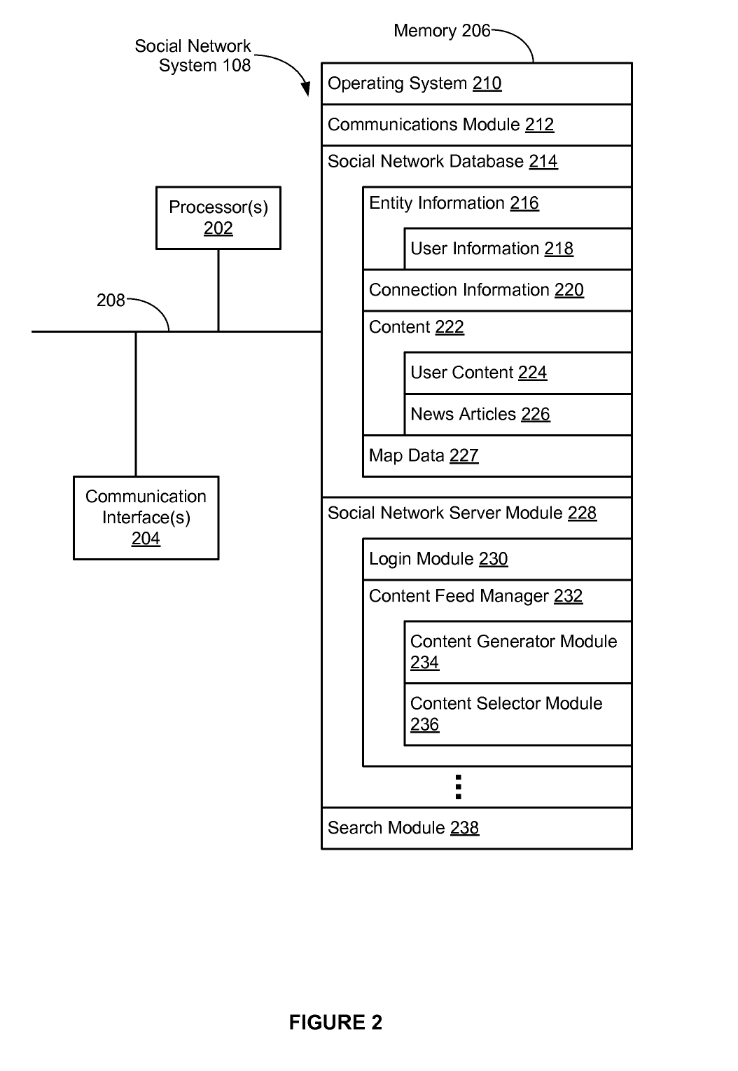

FIG. 2 is a block diagram illustrating an exemplary social-network system 108 in accordance with some embodiments. The social-network system 108 typically includes one or more processing units (processors or cores) 202, one or more network or other communications interfaces 204, memory 206, and one or more communication buses 208 for interconnecting these components. The communication buses 208 optionally include circuitry (sometimes called a chipset) that interconnects and controls communications between system components. The social-network system 108 optionally includes a user interface (not shown). The user interface, if provided, may include a display device and optionally includes inputs such as a keyboard, mouse, trackpad, and/or input buttons. Alternatively or in addition, the display device includes a touch-sensitive surface, in which case the display is a touch-sensitive display.

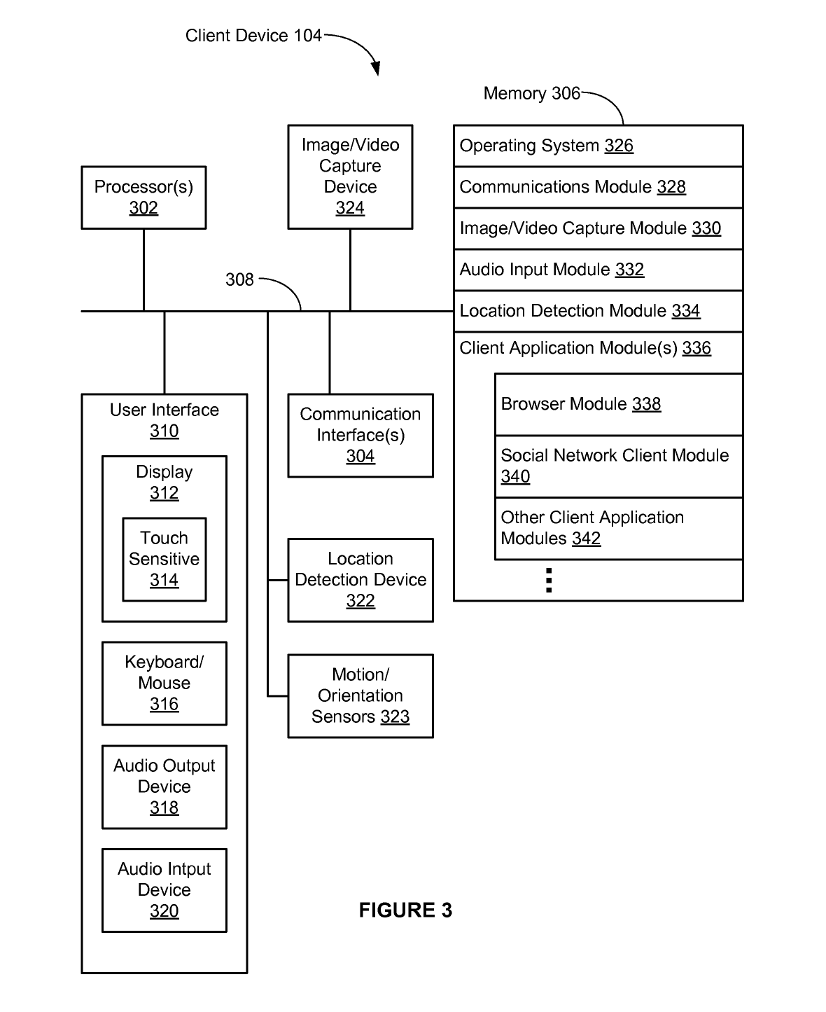

Memory 206 includes high-speed random-access memory, such as DRAM, SRAM, DDR RAM, or other random-access solid-state memory devices; and may include non-volatile memory, such as one or more magnetic disk storage devices, optical disk storage devices, flash memory devices, and/or other non-volatile solid-state storage devices. Memory 206 may optionally include one or more storage devices remotely located from the processor(s) 202. Memory 206, or alternately the non-volatile memory device(s) within memory 206, includes a non-transitory computer-readable storage medium. In some embodiments, memory 206 or the computer-readable storage medium of memory 206 stores the following programs, modules and data structures, or a subset or superset thereof:
an operating system 210 that includes procedures for handling various basic system services and for performing hardware dependent tasks;
a network communication module 212 that is used for connecting the social-network system 108 to other computers via the one or more communication network interfaces 204 (wired or wireless) and one or more communication networks (e.g., the one or more networks 106)
a social network database 214 for storing data associated with the social network, such as:
   entity information 216, such as user information 218;
   connection information 220;
   content 222, such as user content 224 (e.g., content items with embedded content, such as text; photos, videos, or other images; audio; maps; and/or other electronic content with which a user may interact, such as interactive maps, games, etc.) and/or news articles 226; and
   map data 227 that includes associated location information for embedded content (e.g., metadata that includes an associated location of an image, where the associated location indicates a location at which a source media item corresponding to the image was generated);
a social network server module 228 for providing social-networking services and related features (e.g., in conjunction with browser module 338 or social network client module 340 on the client device 104, FIG. 3), which includes:
   a login module 230 for logging a user 102 at a client 104 into the social-network system 108; and
   a content feed manager 232 for providing content to be sent to clients 104 for display, which includes:
      a content generator module 234 for adding objects to the social network database 214, such as images, videos, audio files, comments, status messages, links, applications, and/or other entity information 216, connection information 220, or content 222; and
      a content selector module 236 for choosing the information/content to be sent to clients 104 for display; and
a search module 238 for enabling users of the social-network system to search for content and other users in the social network.

The social network database 214 stores data associated with the social network in one or more types of databases, such as graph, dimensional, flat, hierarchical, network, object-oriented, relational, and/or XML databases.

In some embodiments, the social network database 214 includes a graph database, with entity information 216 represented as nodes in the graph database and connection information 220 represented as edges in the graph database. The graph database includes a plurality of nodes, as well as a plurality of edges that define connections between corresponding nodes. In some embodiments, the nodes and/or edges themselves are data objects that include the identifiers, attributes, and information for their corresponding entities, some of which are rendered at clients 104 on corresponding profile pages or other pages in the social-networking service. In some embodiments, the nodes also include pointers or references to other objects, data structures, or resources for use in rendering content in conjunction with the rendering of the pages corresponding to the respective nodes at clients 104.

Entity information 216 includes user information 218, such as user profiles, login information, privacy and other preferences, biographical data, and the like. In some embodiments, for a given user, the user information 218 includes the user's name, profile picture, contact information, birth date, sex, marital status, family status, employment, education background, preferences, interests, and/or other demographic information.

In some embodiments, entity information 216 includes information about a physical location (e.g., a restaurant, theater, landmark, city, state, or country), real or intellectual property (e.g., a sculpture, painting, movie, game, song, idea/concept, photograph, or written work), a business, a group of people, and/or a group of businesses. In some embodiments, entity information 216 includes information about a resource, such as an audio file, a video file, a digital photo, a text file, a structured document (e.g., web page), or an application. In some embodiments, the resource is located in the social-network system 108 (e.g., in content 222) or on an external server, such as third-party server 110.

In some embodiments, connection information 220 includes information about the relationships between entities in the social network database 214. In some embodiments, connection information 220 includes information about edges that connect pairs of nodes in a graph database. In some embodiments, an edge connecting a pair of nodes represents a relationship between the pair of nodes.

In some embodiments, an edge includes or represents one or more data objects or attributes that correspond to the relationship between a pair of nodes. For example, when a first user indicates that a second user is a “friend” of the first user, the social-network system 108 transmits a “friend request” to the second user. If the second user confirms the “friend request,” the social-network system 108 creates and stores an edge connecting the first user's user node and the second user's user node in a graph database as connection information 220 that indicates that the first user and the second user are friends. In some embodiments, connection information 220 represents a friendship, a family relationship, a business or employment relationship, a fan relationship, a follower relationship, a visitor relationship, a subscriber relationship, a superior/subordinate relationship, a reciprocal relationship, a non-reciprocal relationship, another suitable type of relationship, or two or more such relationships.

In some embodiments, an edge between a user node and another entity node represents connection information about a particular action or activity performed by a user of the user node towards the other entity node. For example, a user may “like” or have “attended,” “played,” “listened,” “cooked,” “worked at,” or “watched” the entity at the other node. The page in the social-networking service that corresponds to the entity at the other node may include, for example, a selectable “like,” “check in,” or “add to favorites” icon. After the user clicks one of these icons, the social-network system 108 may create a “like” edge, “check in” edge, or a “favorites” edge in response to the corresponding user action. As another example, the user may listen to a particular song using a particular application (e.g., an online music application). In this case, the social-network system 108 may create a “listened” edge and a “used” edge between the user node that corresponds to the user and the entity nodes that correspond to the song and the application, respectively, to indicate that the user listened to the song and used the application. In addition, the social-network system 108 may create a “played” edge between the entity nodes that correspond to the song and the application to indicate that the particular song was played by the particular application.

In some embodiments, content 222 includes text (e.g., ASCII, SGML, HTML), images (e.g., jpeg, tif and gif), graphics (e.g., vector-based or bitmap), audio, video (e.g., mpeg), other multimedia, and/or combinations thereof. In some embodiments, content 222 includes executable code (e.g., games executable within a browser window or frame), podcasts, links, and the like.

In some embodiments, the social network server module 228 includes web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), XHP, Javelin, Wireless Universal Resource File (WURFL), and the like.

FIG. 3 is a block diagram illustrating an exemplary client device 104 in accordance with some embodiments. The client device 104 typically includes one or more processing units (processors or cores) 302, one or more network or other communications interfaces 304, memory 306, and one or more communication buses 308 for interconnecting these components. The communication buses 308 optionally include circuitry (sometimes called a chipset) that interconnects and controls communications between system components. The client device 104 includes a user interface 310. The user interface 310 typically includes a display device 312. In some embodiments, the client device 104 includes inputs such as a keyboard, mouse, and/or other input buttons 316. Alternatively or in addition, in some embodiments, the display device 312 includes a touch-sensitive surface 314, in which case the display device 312 is a touch-sensitive display. In some embodiments, the touch-sensitive surface 314 is configured to detect various swipe gestures (e.g., in vertical and/or horizontal directions) and/or other gestures (e.g., single/double tap). In client devices that have a touch-sensitive display 312, a physical keyboard is optional (e.g., a soft keyboard may be displayed when keyboard entry is needed). The user interface 310 also includes an audio output device 318, such as speakers or an audio output connection connected to speakers, earphones, or headphones. Furthermore, some client devices 104 use a microphone and voice recognition to supplement or replace the keyboard. Optionally, the client device 104 includes an audio input device 320 (e.g., a microphone) to capture audio (e.g., speech from a user). Optionally, the client device 104 includes a location detection device 322, such as a GPS (global positioning satellite) or other geo-location receiver, for determining the location of the client device 104. The client device 104 also optionally includes an image/video capture device 324, such as a camera or webcam.

In some embodiments, the client device 104 includes one or more optional sensors 323 (e.g., gyroscope, accelerometer) for detecting a motion and/or change in orientation of the client device. In some embodiments, a detected motion and/or orientation of the client device 104 (e.g., the motion/change in orientation corresponding to a user input produced by a user of the client device) is used to manipulate an interface (or content items within the interface) displayed on the client device 104 (e.g., viewing different portions of a displayed embedded content item).

Memory 306 includes high-speed random-access memory, such as DRAM, SRAM, DDR RAM or other random-access solid-state memory devices; and may include non-volatile memory, such as one or more magnetic disk storage devices, optical disk storage devices, flash memory devices, or other non-volatile solid-state storage devices. Memory 306 may optionally include one or more storage devices remotely located from the processor(s) 302. Memory 306, or alternately the non-volatile memory device(s) within memory 306, includes a non-transitory computer-readable storage medium. In some embodiments, memory 306 or the computer-readable storage medium of memory 306 stores the following programs, modules and data structures, or a subset or superset thereof:
an operating system 326 that includes procedures for handling various basic system services and for performing hardware dependent tasks;
a network communication module 328 that is used for connecting the client device 104 to other computers via the one or more communication network interfaces 304 (wired or wireless) and one or more communication networks, such as the Internet, cellular telephone networks, mobile data networks, other wide area networks, local area networks, metropolitan area networks, and so on;
an image/video capture module 330 (e.g., a camera module) for processing a respective image or video captured by the image/video capture device 324, where the respective image or video may be sent or streamed (e.g., by a client application module 336) to the social-network system 108;
an audio input module 332 (e.g., a microphone module) for processing audio captured by the audio input device 320, where the respective audio may be sent or streamed (e.g., by a client application module 336) to the social-network system 108;
a location detection module 334 (e.g., a GPS, Wi-Fi, or hybrid positioning module) for determining the location of the client device 104 (e.g., using the location detection device 322) and providing this location information for use in various applications (e.g., social network client module 340); and
one or more client application modules 336, including the following modules (or sets of instructions), or a subset or superset thereof:
   a web browser module 338 (e.g., Internet Explorer by Microsoft, Firefox by Mozilla, Safari by Apple, or Chrome by Google) for accessing, viewing, and interacting with web sites (e.g., a social-networking web site provided by the social-network system 108 and/or web sites that are linked to in a social network module 340 and/or an optional client application module 342), such as a web site hosting a service for displaying and accessing content items (e.g., news articles) with embedded content (e.g., text; photos, videos, or other images; audio, maps, and/or other electronic content with which a user may interact)
   a social network module 340 for providing an interface to a social-networking service (e.g., a social-networking service provided by social-network system 108) and related features, such as an interface to a service for displaying and accessing content items (e.g., news articles) with embedded content (e.g., text; photos, videos, or other images; audio; maps; and/or other electronic content with which a user may interact); and/or
   optional client application modules 342, such as applications for displaying and accessing content items (e.g., news articles) with embedded content (e.g., text; photos, videos, or other images; audio; maps; and/or other electronic content with which a user may interact), word processing, calendaring, mapping, weather, stocks, time keeping, virtual digital assistant, presenting, number crunching (spreadsheets), drawing, instant messaging, e mail, telephony, video conferencing, photo management, video management, a digital music player, a digital video player, 2D gaming, 3D (e.g., virtual reality) gaming, electronic book reader, and/or workout support.

Each of the above identified modules and applications correspond to a set of executable instructions for performing one or more functions as described above and/or in the methods described in this application (e.g., the computer-implemented methods and other information processing methods described herein). These modules (i.e., sets of instructions) need not be implemented as separate software programs, procedures or modules, and thus various subsets of these modules are, optionally, combined or otherwise re-arranged in various embodiments. In some embodiments, memory 206 and/or 306 store a subset of the modules and data structures identified above. Furthermore, memory 206 and/or 306 optionally store additional modules and data structures not described above.

Attention is now directed towards embodiments of graphical user interfaces (“GUIs”) and associated processes that may be implemented on a client device (e.g., the client device 104 in FIG. 3).

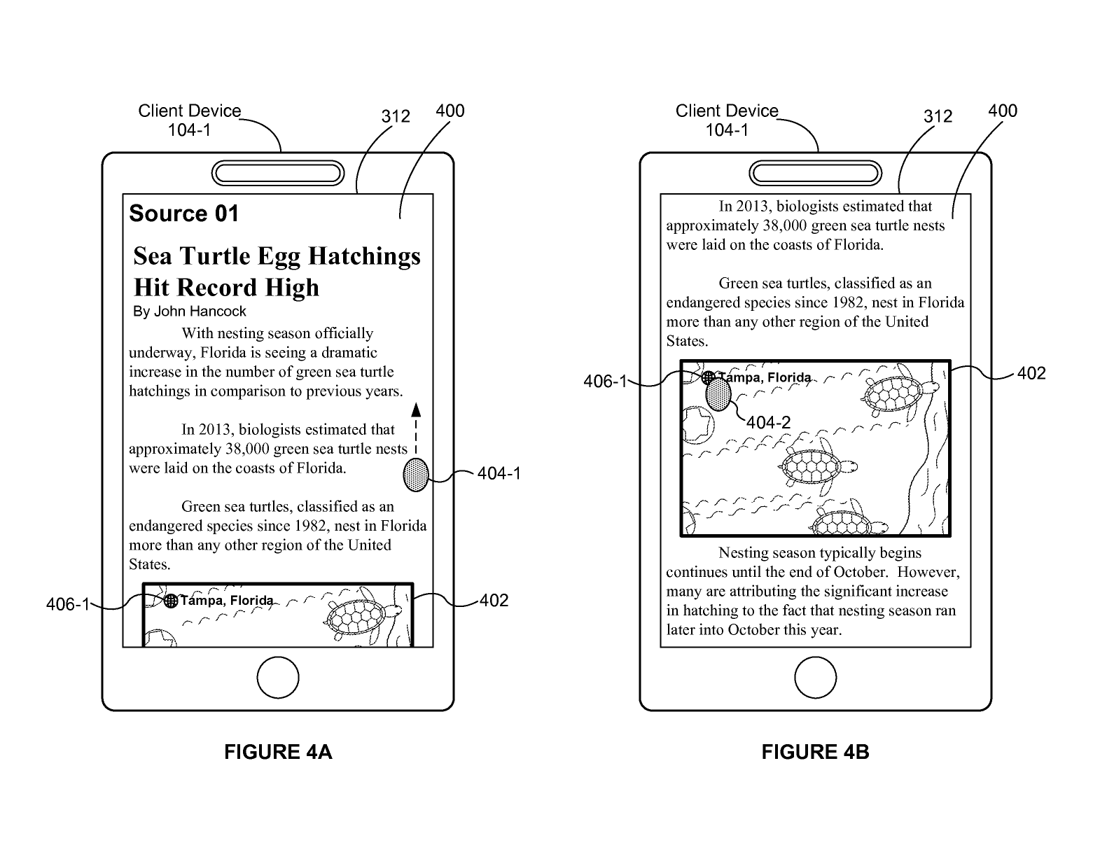

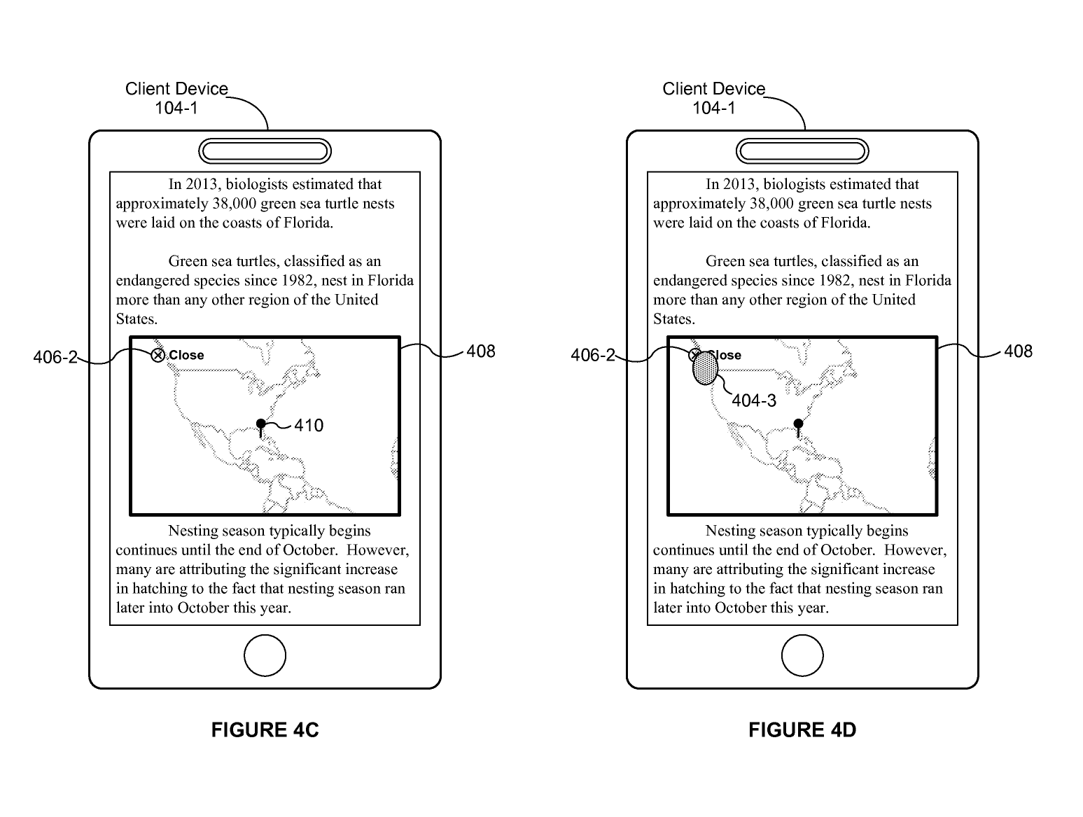

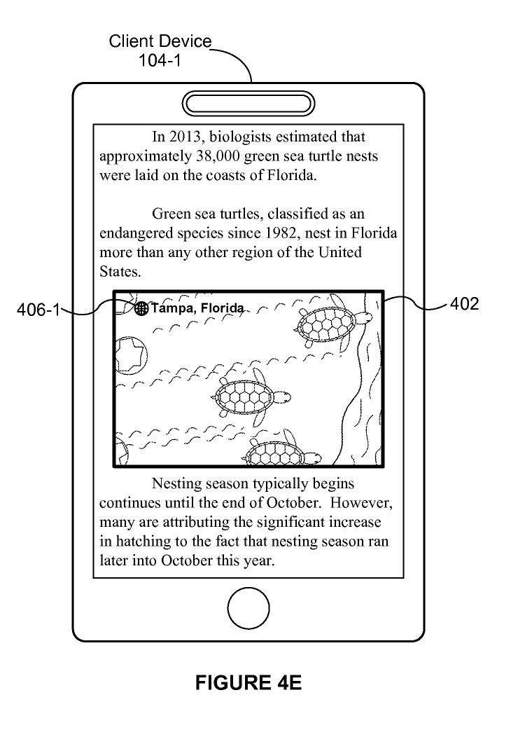

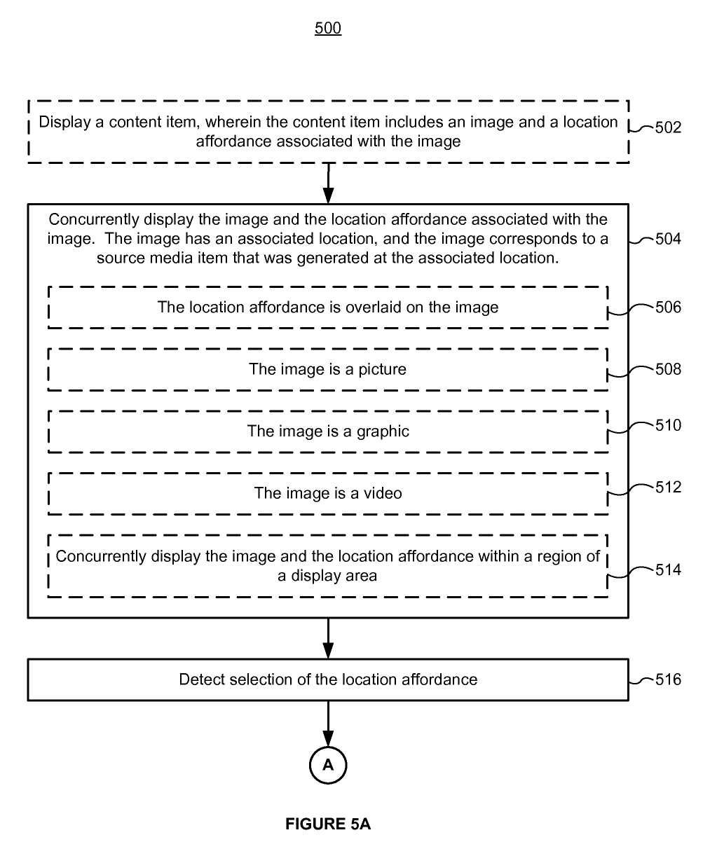

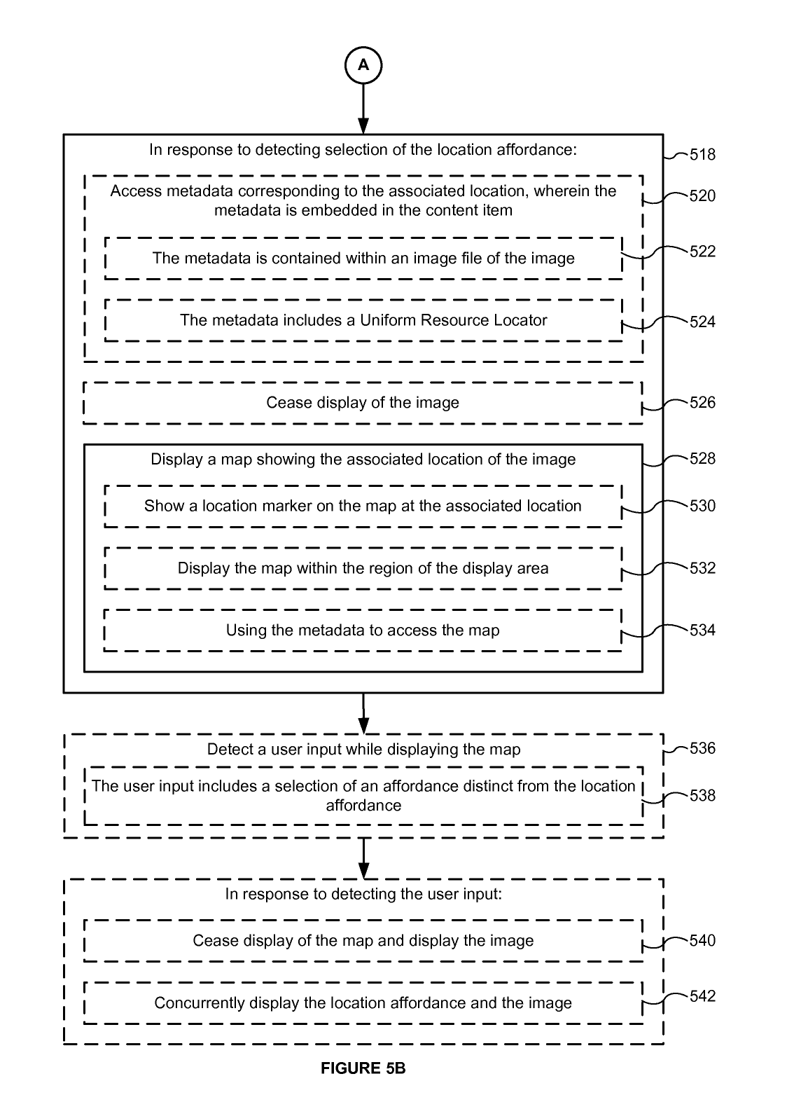

FIGS. 4A-4E illustrate exemplary GUIs on a client device 104 for viewing an associated location of an image, in accordance with some embodiments. The GUIs in these figures are displayed in response to detected user inputs, starting from the displayed content item 400 (FIG. 4A), and are used to illustrate the processes described below, including the method 500 (FIGS. 5A-5B). The GUIs may be provided by a web browser (e.g., web browser module 338, FIG. 3), an application for a social-networking service (e.g., social network module 340), and/or a third-party application (e.g., client application module 342). While FIGS. 4A-4E illustrate examples of GUIs, in other embodiments, a GUI displays user-interface elements in arrangements distinct from the embodiments of FIGS. 4A-4E.

FIGS. 4A and 4B illustrate a GUI for a content item 400 and an image 402 embedded in the content item 400. Content items include various types of formatted content (e.g., web content, such as HTML-formatted documents, or documents in proprietary web formats), including but not limited to news articles, web pages, blogs, user content published via a social-networking service, and/or other types of published content. Content items may include various types of embedded content presentable to a user and with which a user may interact. Examples of embedded content include text, digital media (e.g., photos, videos, other images, audio), and/or other electronic content with which a user may interact (e.g., interactive maps, games, etc.). Embedded content may correspond to a respective source media item (e.g., an original photograph/video) that was generated at an associated location (i.e., the location at which a picture/video was shot). For example, in FIGS. 4A and 4B, the content item 400 is a news article (titled “Sea Turtle Egg Hatchings Hit Record High”) that includes an image 402 (a picture, such as a photo). A location affordance 406-1 is also displayed and superimposed on the image 402. Selection of the location affordance 406-1 results in display of the associated location of the image 402 (shown in FIG. 4C). In this example, the location affordance 406-1 itself displays the associated location of the image 402 (e.g., with text “Tampa, Fla.” that indicates the associated location).

Swipe gesture 404-1 in FIG. 4A corresponds to a vertical scroll for viewing and browsing the content item 400, where the resulting view in FIG. 4B allows the image 402 to be shown in its entirety.

Detecting a gesture 404-2 (e.g., a tap) on the location affordance 406-1 in FIG. 4B results in displaying a map 408 (FIG. 4C) showing the associated location of the image 402 (i.e., the location at which a corresponding source media item was generated). In some embodiments, the map 408 is embedded in the content item 400 (e.g., in a region in which the image 402 was previously displayed). As shown in FIG. 4C, the associated location of the image 402 is indicated by a location marker 410 displayed on the map 408. In this example, the location marker 410 is positioned on the map 408 within the state of Fla., indicating that the corresponding source media item of the image 402 (FIG. 4B) was generated at that location (i.e., the original picture corresponding to image 402 was photographed in Tampa, Fla.).

While displaying the map 408, detecting a gesture 404-3 (e.g., a tap) on an affordance 406-2 in FIG. 4D results in ceasing display of the map 408 and displaying the image 402 (FIG. 4E). In some embodiments, the image 402 is once again embedded in the content item 400 (e.g., in the region where the image 402 had previously been displayed and/or where the map 408 was displayed).

The GUIs shown in FIGS. 4A-4E are described in greater detail below in conjunction with the method 500 of FIGS. 5A-5B.

FIGS. 5A-5B are flow diagrams illustrating the method 500 of viewing embedded content, in accordance with some embodiments. The method 500 is performed on an electronic device (e.g., client device 104, FIGS. 1 and 3). FIGS. 5A-5B correspond to instructions stored in a computer memory (e.g., memory 306 of the client device 104, FIG. 3) or other computer-readable storage medium. To assist with describing the method 500, FIGS. 5A-5B will be described with reference to the exemplary GUIs illustrated in FIGS. 4A-4E.

In the method 500, in some embodiments, the electronic device displays (502) a content item, wherein the content item includes an image and a location affordance associated with the image. As described above, content items include various types of formatted content, which may include different types of embedded content presentable to a user and with which a user may interact. In some embodiments, the content item includes text, and the embedded content includes a picture or graphic. Other examples of content items include but are not limited to web pages, blogs, user content published via a social-networking service, and/or other types of published content. Other examples of embedded content include text, other types of digital media (e.g., videos), and/or other electronic content with which a user may interact (e.g., interactive maps, games, etc.).

The electronic device concurrently displays (504) the image and the location affordance associated with the image. The image has an associated location, and the image corresponds to a source media item (e.g., an original photograph) that was generated at the associated location. The image may, for example, correspond to an image file resulting from post-processing of an original photograph that was physically captured at a particular location, or it may correspond to the original image file of the photograph as captured at the particular location. An example is shown in FIGS. 4A and 4B, where the content item 400 is a news article that includes an image 402 concurrently displayed with a location affordance 406-1. In some embodiments, the location affordance visually indicates the associated location of the image (e.g., the location affordance 406-1 in FIG. 4B includes the text, “Tampa, Fla.”).

In some embodiments, the location affordance is overlaid (504) on the image (e.g., location affordance 406-1 is overlaid on the image 402, FIG. 4B). In other embodiments, the location affordance is positioned (e.g., within the displayed content item) in a region separate from a region in which the image is displayed.

In some embodiments, the image is (508) a picture. In some embodiments, the image is (510) a graphic. In some embodiments, the image is (512) a video.

In some embodiments, the electronic devices concurrently displays (514) the image and the location affordance within a region of a display area. In FIG. 4B, for example, the image 402 and the location affordance 406-1 are displayed within a region of the display area that is approximately at the center of the display device 312.

Selection of the location affordance is detected (516). As shown in FIG. 4B, a gesture 404-2 (e.g., a tap) is detected on the location affordance 406-1. In some embodiments, concurrently displaying (504) the image and the location affordance includes displaying the image at a first resolution, and selection (516) of the location affordance is detected while displaying the image at a second resolution larger than the first resolution (e.g., while displaying the image at a scaled resolution in response to detecting a user input indicating selection of the image, wherein the user input indicating selection of the image precedes selection of the location affordance).

Referring now to FIG. 5B, in some embodiments, in response to detecting (518) selection of the location affordance, the electronic device accesses (520) metadata corresponding to the associated location, wherein the metadata is embedded in the content item (e.g., as metadata included in the HTML script of a news article or other content item). In some embodiments, the metadata is contained (522) within an image file of the image. In some embodiments, the metadata includes (524) a Uniform Resource Locator (e.g., a link, to an online mapping service, that includes location data). The metadata corresponding to the associated location may include a set of coordinates (e.g., GPS coordinates) or any other formatted location data for identifying an associated location or region. In some embodiments, the metadata is in Javascript Object Notation (JSON) format.

In response to detecting (516) selection of the location affordance, the electronic device displays (528) a map showing the associated location of the image. In some embodiments, the electronic device ceases (526) display of the image. In some embodiments, a location marker is shown (530) on the map at the associated location. FIGS. 4B-4C illustrate an example. Here, in response to detecting the gesture 404-2 (e.g., a tap) on the location affordance 406-1, a map 408 is displayed with a location marker 410 placed at the associated location of the image 402 (“Tampa, Fla.”). In some embodiments, once the map is displayed, the location affordance 406-1 is replaced by an affordance 406-2, selection of which results in ceasing display of the map 408 and re-displaying the image 402 (FIGS. 4D-4E).

In some embodiments, displaying (528) the map includes displaying (532) the map within the region of the display area (i.e., the region in which the image is displayed prior to displaying the map). In some embodiments, the map is displayed within a region of the display area distinct from the region in which the image is displayed. In some embodiments, the map is overlaid on the image (e.g., the map at least partially covers the image).

In some embodiments, displaying (528) the map includes displaying an animation of a transition from displaying the image to displaying the map. Examples of animations include an animation in which the image is flipped (e.g., image 402 displayed on one side, and the map 408 displayed on the other side), an animation in which the map expands into view (e.g., until the map fills the region of the display area), an animation in which the map slides into view (e.g., from off the screen), or an animation in which the map fades into view.

In some embodiments, displaying (528) the map includes using (534) the metadata to access the map. As an example, in response to detecting selection of the location affordance 406-1 (FIG. 4B), the client device 104-1 accesses a URL embedded within the image 402 and retrieves the association location data of the image for display on the client device 104-1.

In some embodiments, the electronic device concurrently displays (504) the image and the location affordance within an application running on the electronic device (e.g., a social network client module 340, FIG. 3), and displays (528) the map within the application in response to detecting selection of the location affordance. Thus, the map is loaded and displayed within the same application in which the content item and image are being viewed without switching to a different application. In other embodiments, the electronic device concurrently displays (504) the image and the location affordance within a first application running on the electronic device (e.g., a social network client module 340, FIG. 3), and displays (528) the map within a second application (e.g., a browser module 338, FIG. 3) running on the electronic device, distinct from the first application.

In some embodiments, a user input is detected (536) while displaying (528) the map. In some embodiments, the user input includes (538) a selection of an affordance distinct from the location affordance (e.g., an affordance 406-2 for ceasing display of the map 408, FIG. 4D). In other embodiments, the user input includes (538) a selection of the location affordance (e.g., which continues to be displayed while the map is being displayed). In some embodiments, in response to detecting (536) the user input, the electronic device ceases (540) display of the map and displays the image. An example is shown in FIGS. 4D-4E. Here, a gesture 404-3 is detected on the affordance 406-2 (FIG. 4D). In response, the client device 104-1 ceases display of the map 408 and re-displays the image 402 (FIG. 4E). In some embodiments, in response to detecting (536) the user input, the electronic device concurrently displays (542) the location affordance and the image.

For situations in which the systems discussed above collect information about users, the users may be provided with an opportunity to opt in/out of programs or features that may collect personal information (e.g., information about a user's preferences or a user's contributions to social content providers). In addition, in some embodiments, certain data may be anonymized in one or more ways before it is stored or used, so that personally identifiable information is removed. For example, a user's identity may be anonymized so that the personally identifiable information cannot be determined for or associated with the user, and so that user preferences or user interactions are generalized (for example, generalized based on user demographics) rather than associated with a particular user.

Although some of various drawings illustrate a number of logical stages in a particular order, stages which are not order dependent may be reordered and other stages may be combined or broken out. While some reordering or other groupings are specifically mentioned, others will be apparent to those of ordinary skill in the art, so the ordering and groupings presented herein are not an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A method, comprising:
at an electronic device having one or more processors and memory storing instructions for execution by the one or more processors:
concurrently displaying an image and a location affordance associated with the image, wherein the image has an associated location, and wherein the image corresponds to a source media item that was generated at the associated location;
detecting selection of the location affordance; and
in response to detecting selection of the location affordance, displaying a map showing the associated location of the image.

2. The method of claim 1, wherein displaying the map comprises showing a location marker on the map at the associated location.

3. The method of claim 1, wherein the location affordance is overlaid on the image.

4. The method of claim 1, wherein the image is a picture.

5. The method of claim 1, wherein the image is a graphic.

6. The method of claim 1, wherein the image is a video.

7. The method of claim 1, further comprising ceasing display of the image in response to detecting selection of the location affordance.

8. The method of claim 7, further comprising:
detecting a user input while displaying the map; and
in response to detecting the user input:
ceasing display of the map; and
displaying the image.

9. The method of claim 8, further comprising, in response to detecting the user input, concurrently displaying the location affordance and the image;
wherein the user input comprises a selection of an affordance distinct from the location affordance.

10. The method of claim 1, wherein:
concurrently displaying the image and the location affordance comprises concurrently displaying the image and the location affordance within a region of a display area; and
displaying the map comprises displaying the map within the region of the display area.

11. The method of claim 1, further comprising displaying a content item, wherein the content item includes the image and the location affordance.

12. The method of claim 11, further comprising, in response to detecting selection of the location affordance, accessing metadata corresponding to the associated location, wherein the metadata is embedded in the content item;
wherein displaying the map comprises using the metadata to access the map.

13. The method of claim 12, wherein the metadata is contained within an image file of the image.

14. The method of claim 12, wherein the metadata comprises a Uniform Resource Locator.

15. The method of claim 1, further comprising, in response to detecting selection of the location affordance, accessing metadata corresponding to the associated location, wherein the metadata is contained within an image file of the image;
wherein displaying the map comprises using the metadata to access the map.

16. The method of claim 1, wherein:
concurrently displaying the image and the location affordance is performed within an application running on the electronic device; and
displaying the map in response to detecting selection of the location affordance is performed within the application.

17. An electronic device, comprising:
one or more processors; and
memory storing one or more programs for execution by the one or more processors, the one or more programs including instructions for:
concurrently displaying an image and a location affordance associated with the image, wherein the image has an associated location, and wherein the image corresponds to a source media item that was generated at the associated location;
detecting selection of the location affordance; and
in response to detecting selection of the location affordance, displaying a map showing the associated location of the image.

18. The electronic device of claim 17, wherein displaying the map comprises showing a location marker on the map at the associated location.

19. A non-transitory computer-readable storage medium storing one or more programs for execution by one or more processors of an electronic device, the one or more programs including instructions for:
concurrently displaying an image and a location affordance associated with the image, wherein the image has an associated location, and wherein the image corresponds to a source media item that was generated at the associated location;
detecting selection of the location affordance; and
in response to detecting selection of the location affordance, displaying a map showing the associated location of the image.

20. The computer-readable storage medium of claim 19, wherein displaying the map comprises showing a location marker on the map at the associated location.
